(19) United States
(12) Patent Application Publication
(10) Pub. No.: US 2009/0262926 A1
(43) Pub. Date: Oct. 22, 2009

(54) METHOD AND APPARATUS FOR GENERATING A CRYPTOGRAPHIC KEY

(75) Inventors: Mayank Kabra, Maharastra (IN); Uma Ranjan, Bangalore (IN); Dipu Vikram, Kerala (IN); Brajesh Kumar, Uttar Pradesh (IN)

Correspondence Address: DICKSTEIN SHAPIRO LLP, 1633 Broadway, NEW YORK, NY, 10019, US

(73) Assignee: INFINEON TECHNOLOGIES AG, Neubiberg (DE)

(21) Appl. No.: 12/103,923

(22) Filed: Apr. 16, 2008

(51) Int. Cl. H04L 9/00; G06F 17/00

(52) U.S. Cl. 380/44; 707/100; 707/E17.001

(57) ABSTRACT

In embodiments methods and circuits for generating a cryptographic key, for encrypting and decrypting data with the generated key, for storing and reading the encrypted data using a filename unknown to a running application of a mobile computer application are provided.

### TECHNICAL FIELD

Embodiments relate generally to a method for generating a cryptographic key, a method for storing a file, a method for reading a file, a key generating circuit and a cryptographic circuit, and a cryptographic circuit arrangement.

### BACKGROUND

By way of example, mobile phones store data in a general area which may be accessed by many computer programs. This may enable a computer application to read any other computer application's data and/or keys. In a system where authorization to data is granted for a computer application and not for all computer applications on the device, it may be desired to restrict the data that can be read by a computer application. It is also desirable to ensure that the additional access control does not cause any overhead in processing or time taken to access the information.

Conventionally, the access control is routed through a module which verifies the identity of the application against a stored database (e.g. an Access Control List) before allowing access. This has two effects: firstly, the verification involves additional time and secondly, the access control list/table of permitted identities is stored securely.

Another conventional system implies that data can be stored by encrypting with a cryptographic key derived from supplied information. The cryptographic key is stored in a table which is protected by another cryptographic key. The effect of such a method is that the table is accessed first to retrieve the cryptographic key and in a second access, the cryptographic key is used to decrypt the actual data. If the access control list or table is corrupted, all data is irretrievable although they are not corrupted. Updating of the table also needs to be done under secure conditions (like semaphores). Moreover, such a method when used in a device like a cell-phone is not immune to flash change attacks as flash can be removed and loaded onto another phone where the data can be decrypted.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of embodiments. In the following description, various embodiments are described with reference to the following drawings, in which:

FIG. 1 shows a method for generating a cryptographic key in accordance with an embodiment;

FIG. 2 shows the generation of a cryptographic key in accordance with an embodiment;

FIG. 3 shows a method for storing a file in accordance with an embodiment;

FIG. 4 shows the storing of a file in accordance with an embodiment;

FIG. 5 shows a method for reading a file in accordance with an embodiment;

FIG. 6A shows a key generating circuit in accordance with an embodiment;

FIG. 6B shows a conventional key generating circuit;

FIG. 6C shows the key generating circuit based on the conventional key generating circuit in accordance with an embodiment;

FIG. 7 shows a cryptographic circuit in accordance with an embodiment; and

FIG. 8 shows a cryptographic circuit arrangement in accordance with an embodiment.

### DESCRIPTION

Embodiments provide a method for generating a cryptographic key and a key generating circuit for storing and reading data, e.g. in mobile phones. The key may be used, in accordance with various embodiments, in a cryptographic circuit arrangement to encrypt and store the data from a computer application program and to decrypt encrypted data from the storage after reading the stored data.

Various embodiments provide a method for storing a file and a method for reading a file ensuring that application data can be accessed (read successfully) only by the same (computer) application. The methods described may not add any overhead to perform the authentication and only involve the additional time taken for cryptographic routines.

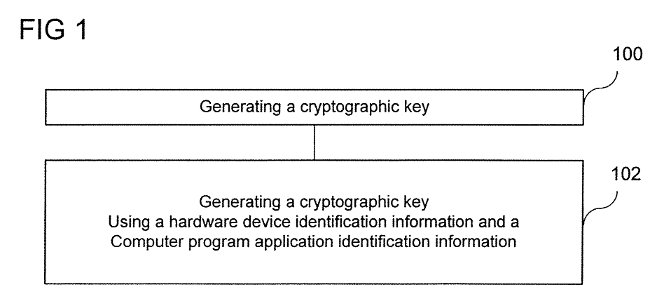

FIG. 1 shows in an embodiment a method 100 for generating a cryptographic key. In accordance with this embodiment, in 102, the cryptographic key is generated using a hardware device identification information and an application computer program identification information.

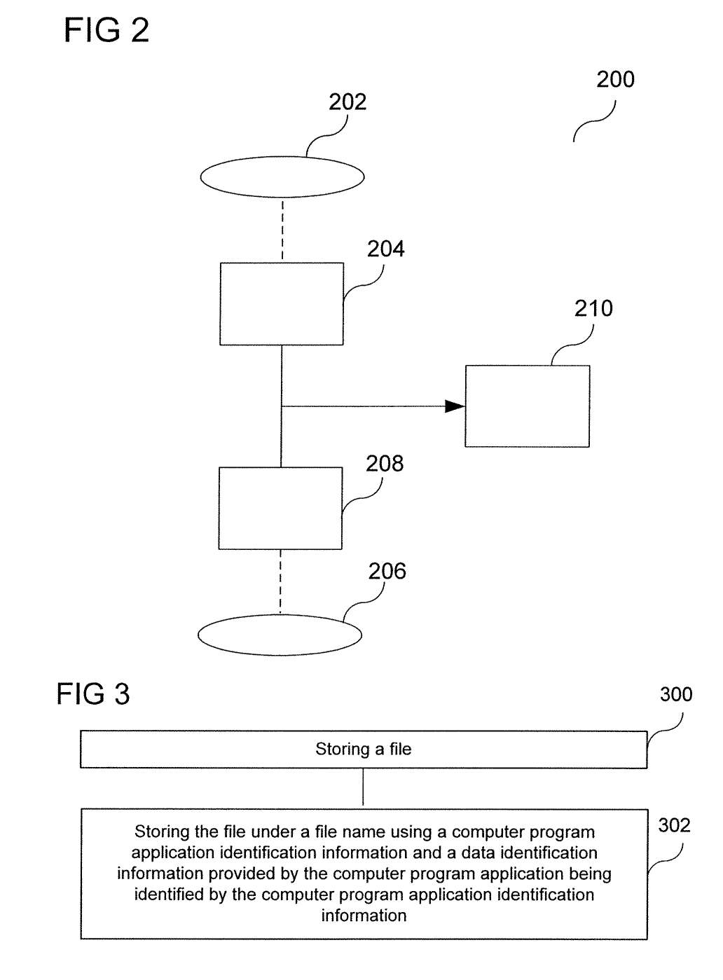

FIG. 2 illustrates the method 200 for generating a cryptographic key. An application computer program identifier 204 identifying the application computer program 202 which is automatically derived—e.g. from the operating system-defined task list or from the application code residing on the flash—is used in combination with a hardware unique key 208 of the hardware 206 to derive the cryptographic key 210 for encryption or decryption, respectively. In this way the flash replacement attack is addressed.

The hardware unique key 208 may be a value or number that can be used to uniquely identify the hardware, e.g. a device. The hardware unique key 208 may include individually, or a combination of, the processor ID and the flash ID, or any other unique identification information identifying a whole device or a component of the device such as e.g. a processor, a memory component, an amplifier component, a transceiver component, etc. It may also include a special value stored within the processor explicitly for this purpose.

It should be noted that in the drawings of this description different boxes and reference numbers are used for the ‘hardware device’ and for the processor. However, the ‘hardware device’, i.e. the device from which the key is partially derived, and the processor on which the application computer program is running do not need to be, but may be, one and the same circuit.

Furthermore, a hardware device may be a removable device, in other words, a device that is removable from the device that includes the processor that is running the application computer program. An example for a removable device is a removable memory card or a removable memory stick.

For maximum security, the device hardware unique key should not be easily accessible and should adhere to the recommendations of the OMTP TR#0 and OMTP TR#1 (Open Mobile Terminal Platform Hardware Requirements and Defragmentation, Trusted Environment) relating to access and usage.

In an embodiment, the cryptographic key may be generated while the application computer program 202 being identified by the application computer program identification information 204 is running.

In other words, the cryptographic key 210 may be derived at runtime every time the application computer program has been started and is not stored. Since the data may also be tied to the specific hardware device identifier 208 as mentioned above, this method is immune to flash removal attacks.

In an embodiment, the application computer program identification information 204 is unknown to the application computer program 202 being identified by the application computer program identification information 204.

For that, in an embodiment, an application identification information generating circuit may be provided, as explained further below.

This means, a unique device identifier 208 and an application identity 204 which is derived in a manner unknown to the application computer program 202 may be used to derive the application-specific cryptographic key 210 which may be used to encrypt or decrypt data.

In an embodiment, the hardware device may be a device selected from a group of devices consisting of: a chip; a part of a chip; a memory device, or any kind of electronic circuit which may uniquely be identified by an assigned identifier.

Examples of such devices are microprocessors, smartcards, SIM cards, flash memories, USB devices as e.g. USB devices for communication or for mass storage, hard disk drives, e.g. hard disk drives for mobile use, FPGAs (Field Programmable Gate Arrays), etc.

In an embodiment the method 100 may be used in a mobile radio device, such as e.g. a mobile phone, a PDA (Personal Digital Assistant), a palm, a pocket pc (pocket personal computer), a digital camera, or any other mobile device with computing and radio capabilities and on which one or more application computer programs may be run, in other words, executed.

In an example, the application computer program may obtain a one-time registration information from which the application identification information is derived in a manner unknown to the application computer program.

FIG. 3 shows in an embodiment a method 300 for storing a file. In accordance with this method, in 302, the file may be stored under a file name using an application computer program identification information and a data identification information provided by the application computer program being identified by the application computer program identification information.

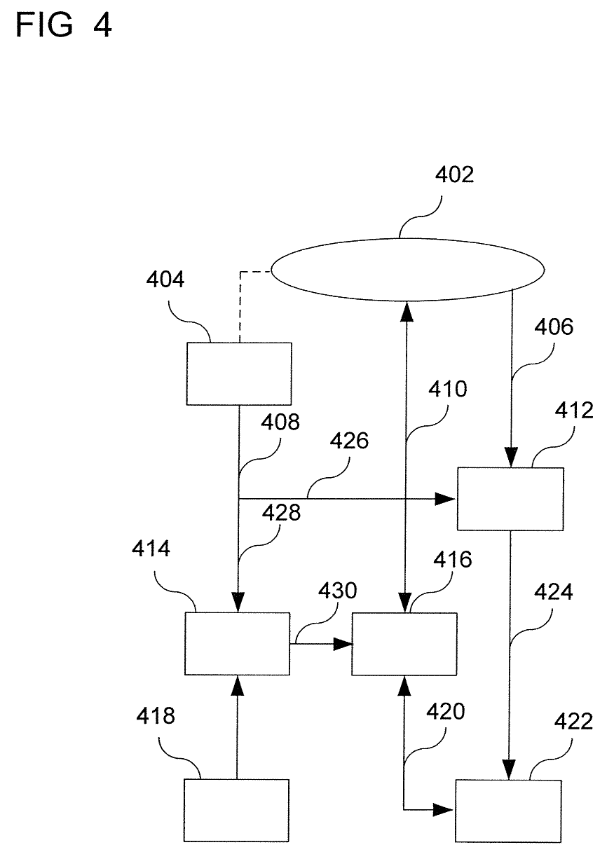

The method 300 is illustrated in FIG. 4. An application identification information 408 is derived from an application computer program 402. Furthermore, a data identification information 406 identifying the data 410 may be derived from the application 402, for generating the file name 412 for the file 422.

The encrypted data is thus stored in the file 422 which name 412 indicates both the application identity 408 as well as an application-supplied identifier 406 for the data.

The file name 412 may be derived from a combination of the application identity 408 as well as the application-supplied data identifier 406.

Examples may include, but are not restricted to:

/home/data/appld/dataId.dat

/home/store/secure/appId_dataId.dat.

A part of the process of derivation of the cryptographic key, wherein the cryptographic key is represented by an arrow 430 in FIG. 4 (which in an embodiment may be the raw key), also results in a derivation of the file name 412 by which the data 410 is stored, as indicated by arrows 428, 430, and arrow 426, respectively. Arrow 408 is split into two arrows 428, 430 just for reasons of demonstrating this derivation of the file name 412, however, they contain the same application computer program identification information.

Hence, in an embodiment, there is no need to access or maintain a separate table of data entries. This also has the effect that any corruption of a file only affects the specific file and not any other file.

In an embodiment, the method 300 may further include generating a cryptographic key using a hardware device identification information 418 and an application computer program identification information 408. Furthermore, the method may include encrypting the file 422 using the cryptographic key 430.

In an example, a one-time registration information may be obtained from which the application identification information is derived in a manner unknown to the application computer program.

A faster access may be achieved by avoiding completely an access control list or a table access and thereby also the associated problems of maintaining the entries of the table.

In an embodiment, the cryptographic key 430 is generated while the application computer program 402 being identified by the application computer program identification information 408 is running, in other words, executed.

As mentioned above, by generating the key 430 at runtime, the storing of the cryptographic key, e.g. in a list or table is avoided, and the cryptographic key can be provided in a fast and secure manner.

In an embodiment, the application computer program identification information 408 of method 300 is unknown to the application computer program 402 being identified by the application computer program identification information 404.

In an embodiment, the hardware device 206 (the identity of the hardware device is denoted with 418) of method 300 may be a device selected from a group of devices consisting of: a chip; a part of a chip; a memory device, as e.g. micro processors, smartcards, SIM cards, flash memories, USB devices as e.g. USB devices for communication or for mass storage, hard disk drives, especially hard disk drives for mobile use, FPGAs (Field Programmable Gate Arrays), etc.

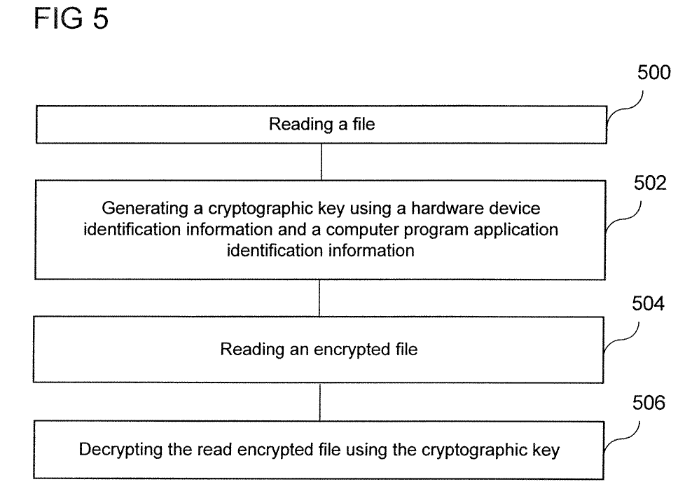

In an embodiment, a method 500 for reading a file is provided, as shown in FIG. 5. In accordance with this embodiment, in 502, a cryptographic key is generated using a hardware device identification information and an application computer program identification information. In 504 an encrypted file is read. Furthermore, in 506, the read encrypted file is decrypted using the cryptographic key.

Referring to FIG. 4, in accordance with the method 500, the encrypted file 422 may be read by the application computer program 202. The encrypted data 420 of the file 422 may be decrypted by the ciphering/deciphering circuit 416 using the cryptographic key 430. The key 430 was generated or built using application computer program identification information 428 and hardware device identification information 418.

The ciphering/deciphering circuit 416 encrypts the data to be stored 410 by the application 202 using the cryptographic, application-specific master key 430. During retrieval, the encrypted data 420 may be decrypted by the cryptographic, application-specific master key 430 and returned to the application 202.

In an embodiment, the cryptographic key 430 of method 500 for reading a file may be generated while the application computer program 202 being identified by the application computer program identification information 428 is running.

In an embodiment, the application computer program identification information 428 of method 500 may be unknown to the application computer program 202 being identified by the application computer program identification information 428.

In an embodiment, method 500 may further include the application computer program 202 being identified by the application computer program identification information 428 requesting to read the file 422.

In an embodiment, the hardware device 206 of method 500 may be a device selected from a group of devices consisting of: a chip; a part of a chip; a memory device, as e.g. smartcards, SIM cards, flash memories, USB devices as e.g. USB devices for communication or for mass storage, hard disk drives, especially hard disk drives for mobile use, etc.

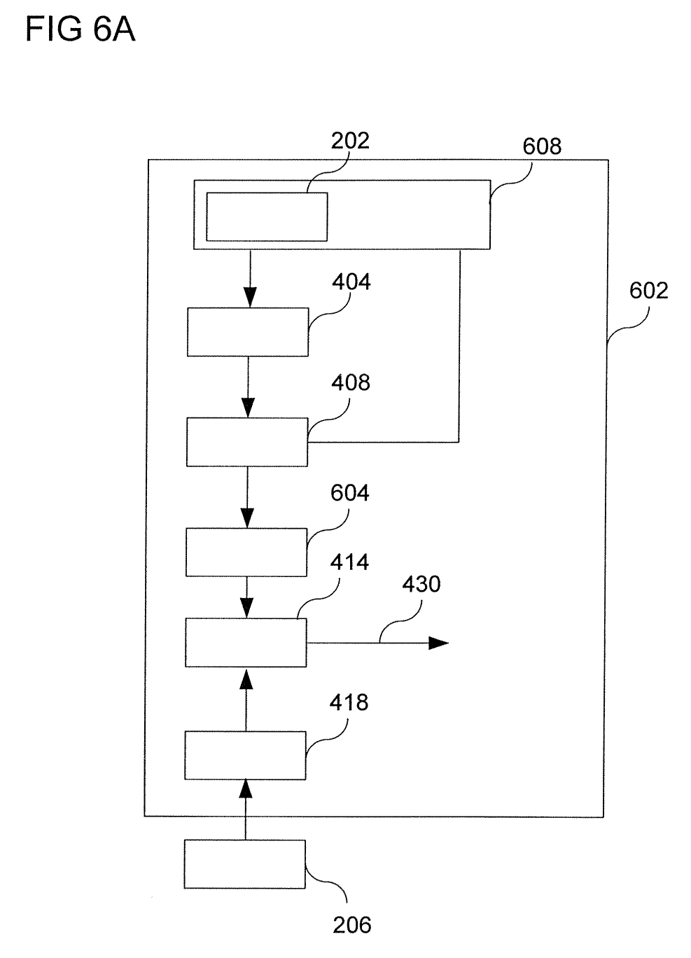

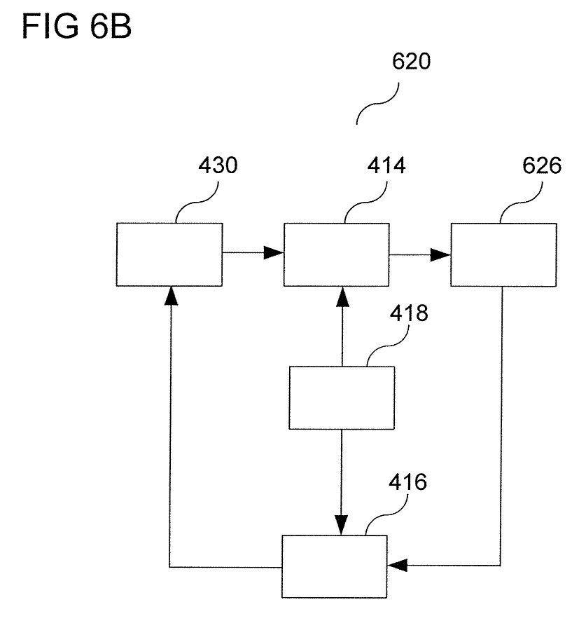

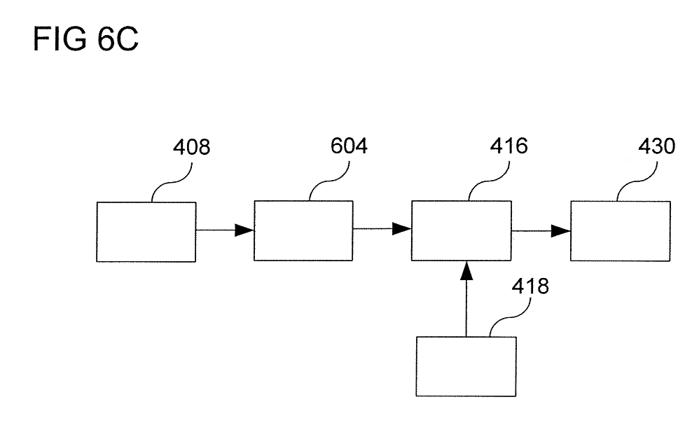

In accordance with an embodiment, a key generating circuit for generating a cryptographic key may be provided. As show in FIG. 6A, in accordance with this embodiment, the key generating circuit 602 may be configured to generate the cryptographic key 430 using a hardware device identification information 418 and an application computer program identification information 408.

The key generating circuit 602 may use any method which combines the application identity 408 as well as the hardware device unique key 418 of the hardware device 206. For example, this may be a logical combination of the IDs, or a combination of e.g. the hardware device identification information 408 with the hash value of the application computer program identification information 408. The combination may also be based on any conventional algorithm for generating a digital key.

However, some systems conventionally use the hardware device unique key 418 to encrypt keys, as shown in a diagram 620 in FIG. 6B. In order to maintain the same interpretation and have the possibility to re-use any in-built hardware features for secure handling of the hardware unique key 418, an embodiment of the key generating circuit 414 is, as depicted in FIG. 6C, to consider the application identity 408 (or a digest 604 of it, as e.g. a hash value) as a wrapped key 626, from which the key for encryption 430 may be derived by decryption 416 using the hardware unique key 418. No part of the key 430 is stored in this embodiment, thereby making it unnecessary to maintain storage and integrity of the key 430 in any form (raw or wrapped). This method also involves less time for key derivation compared to current systems which first retrieve a wrapped key 626 and then unwrap it to obtain the raw key 430.

The key generating circuit 602 in an embodiment may further contain a processor 608 configured to run the application computer program 202 being identified by the application computer program identification information 408; wherein the key generating circuit 602 is configured to generate the cryptographic key while the processor 608 runs the application computer program 202 being identified by the application computer program identification information 408.

Since the key 210 is derived at runtime the generation of the key may be immune to flash removal attacks

In an embodiment, the key generating circuit 602 may further contain an application computer program identification information generating circuit 404 configured to generate the application computer program identification information 408.

It is the application computer program identification information generating circuit 404 which may finally determine the security of the system and the possibility of attacks by other applications. In operating systems in which a task structure is available, the task identity may be obtained from the specific fields in or derived from the task structure. If the application data is available as a separate file (as e.g. in the case of Unix executable files), the full name of the file (including preceding path) or a hash value of the file as stored on the flash may be used as the identity.

In systems where the operating system is not capable of distinguishing between the identities of different applications or tasks are filtered through a microkemel or a middleware, each application may need to perform a registration before first use and supply this registered identity for every use. However, this is the least secure way of identifying an application since the application is relied on to publish its identity.

In an embodiment, the application computer program identification information generating circuit 404 of the key generating circuit 602 is configured to generate the application computer program identification information 408 such that it is unknown to the application computer program 202 being identified by the application computer program identification information 408.

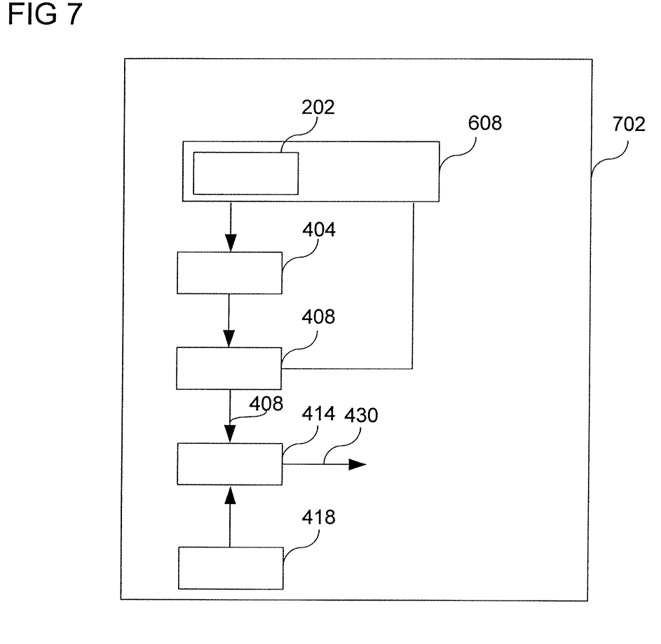

FIG. 7 shows an embodiment in accordance with which a cryptographic circuit 702 is provided that contains a key generating circuit 602 for generating a cryptographic key 430, wherein the key generating circuit 414 is configured to generate the cryptographic key 430 using a hardware device identification information 418 and an application computer program identification information 408; and wherein the cryptographic circuit 702 is configured to provide a cryptographic mechanism using the generated cryptographic key 430.

The key generating circuit of this embodiment may be the above described key generating circuit 602.

In an embodiment, the cryptographic circuit 702 is configured to provide a cryptographic mechanism selected from a group of cryptographic mechanisms consisting of: encryption; decryption; authentication; generation of hash values.

In an embodiment, the cryptographic circuit 702 further contains a processor 608 configured to run the application computer program 202 being identified by the application computer program identification information 408.

Further, in accordance with this embodiment, the key generating circuit 414 may be configured to generate the cryptographic key 430 while the processor 608 runs the application computer program 202 being identified by the application computer program identification information 408.

In an embodiment, the cryptographic circuit 702 may further contain an application computer program identification information generating circuit 404 configured to generate the application computer program identification information 408.

In an embodiment, the application computer program identification information generating circuit 404 of the cryptographic circuit 702 may be configured to generate the application computer program identification information 408 such that it is unknown to the application computer program 202 being identified by the application computer program identification information 408.

It should be noted that, because in accordance with the embodiment above the application computer program does not know the application computer program identifier, the process for accessing the file with the correct file name is analogous to the process for storing a file; i.e. the file name has to be generated by all circuits involved in the file name generation process as explained above.

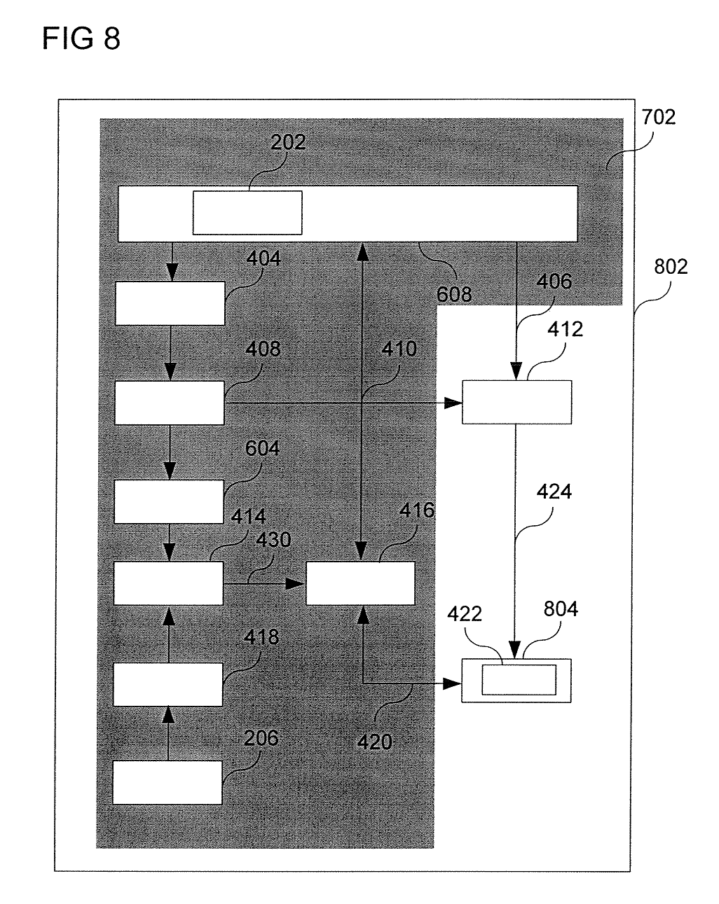

In an embodiment, a cryptographic circuit arrangement 802 is provided. The cryptographic circuit arrangement is depicted in FIG. 8. It contains a key generating circuit 414 for generating a cryptographic key 430, wherein the key generating circuit 414 is configured to generate the cryptographic key 430 using a hardware device identification information 418 and an application computer program identification information 428, a cryptographic circuit 702 configured to provide a cryptographic mechanism using the generated cryptographic key 430, and a hardware device 206 being identified by the hardware device identification information 418.

The cryptographic circuit 702 in FIG. 8 may be a cryptographic circuit in accordance with the embodiments described above and FIG. 7.

In an embodiment the cryptographic circuit 702 of the cryptographic circuit arrangement 802 may be configured to provide a cryptographic mechanism selected from a group of cryptographic mechanisms consisting of: encryption; decryption; authentication; generation of hash values.

In an embodiment, the cryptographic circuit arrangement 802 further contains: a processor configured to run the application computer program being identified by the application computer program identification information; wherein the key generating circuit may be configured to generate the cryptographic key while the processor runs the application computer program being identified by the application computer program identification information.

As mentioned above, by generating the key 430 at runtime, the storing of the key 430, e.g. in a list or table is avoided, and the cryptographic key can be provided in a fast and secure manner.

In an embodiment, the cryptographic circuit arrangement 802 may further contain an application computer program identification information generating circuit 404 configured to generate the application computer program identification information 408.

The application computer program identification information generating circuit 404 may be part of the cryptographic circuit 702. It may generate the application identification information 408 based on properties of the application 202 such as e.g. the application name or on other methods allowing an identification of the application 202.

In an embodiment, the application computer program identification information generating circuit 404 of the cryptographic circuit arrangement 802 may be configured to generate the application computer program identification information 408 such that it is unknown to the application computer program being identified by the application computer program identification information 408.

The application 202 hence does not have the possibility to derive the name 424 of the file 422 to which its data are written to. The file name is generated by all circuits involved in the file name generation process as explained above.

In an embodiment, the hardware device of the cryptographic circuit arrangement may be a device selected from a group of devices consisting of: a chip; a part of a chip; a memory device.

Such devices are e.g. micro processors, smartcards, SIM cards, flash memories, USB devices as e.g. USB devices for communication or for mass storage, hard disk drives, especially hard disk drives for mobile use, FPGAs (Field Programmable Gate Arrays), etc.

In an embodiment, the cryptographic circuit arrangement 802 further contains a memory 804 to store an encrypted file, wherein the memory 804 has a memory interface 420 coupled with the cryptographic circuit 702 to exchange the encrypted file 422 between the memory 804 and the cryptographic circuit 702.

The memory 804 may be a built-in memory or an external flash memory, as e.g. Secure Digital (SD) Memory Card, Micro Multimedia Card (MMC) or a Compact Flash (CF), a USB storage device, a memory on a smart card, as e.g. a SIM card or a USIM card, a hard disk drive, especially a portable hard disk drive, an optical or digital magnetic memory device, etc.

In an embodiment, the cryptographic circuit arrangement 802 may further contain a name generating circuit 412 coupled with the memory 804 and the cryptographic circuit 702, wherein the file name generating circuit 412 may be configured to generate a file name 424 for the encrypted file 422 to be stored in the memory 804 using an application computer program identification information 408 and a data identification information 406 provided by the application computer program 202 being identified by the application computer program identification information 408.

In an embodiment, a communication device is provided that contains a cryptographic circuit arrangement 802, containing: a key generating circuit 414 for generating a cryptographic key 430, wherein the key generating circuit 414 is configured to generate the cryptographic key 430 using a hardware device identification information 418 and an application computer program identification information 408; a cryptographic circuit 702 configured to provide a cryptographic mechanism using the generated cryptographic key 430; a hardware device 206 being identified by the hardware device identification information 418; and a communication circuit configured to provide at least one communication service.

The mobile communication service may be a speech and/or data communication service. Such services are provided by communication standards, as e.g. the mobile radio communication standards GSM (Global System for Mobile Communications), UMTS (Universal Mobile Telecommunications System), FOMA (Freedom of Mobile Multimedia Access), International Mobile Telecommunications-2000) or wireless standards, as e.g. IEEE (Institute of Electrical and Electronics Engineers)-WLAN (Wireless Local Area Networks) standards, Bluetooth, etc.

In an embodiment, the cryptographic circuit 702 of the communication device is configured to provide a cryptographic mechanism selected from a group of cryptographic mechanisms consisting of: encryption; decryption; authentication; generation of hash values.

In an embodiment, the communication device further contains a processor configured to run the application computer program 202 being identified by the application computer program identification information 418; wherein the key generating circuit 430 is configured to generate the cryptographic key 430 while the processor 608 runs the application computer program 202 being identified by the application computer program identification information 408.

In an embodiment, the communication device further contains an application computer program identification information generating circuit 404 configured to generate the application computer program identification information 408.

In an embodiment, the application computer program identification information generating circuit 404 of the communication device is configured to generate the application computer program identification information 408 such that it is unknown to the application computer program 202 being identified by the application computer program identification information 408.

In an embodiment, the hardware device 206 of the communication device may be a device selected from a group of devices consisting of: a chip; a part of a chip; a memory device.

In an embodiment, the communication device is configured as a radio communication device.

In an embodiment, the communication device is configured as a mobile radio communication device.

In current methods of secure data storage, the data handler is not decided by the application but by the secure storage module. This has the negative effect that applications cannot use code-hiding methods to hide the identifier (since it is only available at run-time). The secure storage module also needs to keep track of all supplied identifiers across applications. In contrast, in an embodiment, the identifier is decided by the application and the application can use any code-hiding method to prevent static attacks on the code. Further, each application maintains its own set of identifiers and there is no need for any coordination across module to determine data identifiers. Uniqueness across applications is achieved by using a combination of application names as well as the supplied data identifier.

As an effect,

Data belonging to one application cannot be accessed by any other application on the same device.

Flash removed from one device cannot be used on another device.

Access to the secure data in one step (direct access) instead of a two-step access via a data entry table.

The security of the system can be adjusted through the manner in which the identity of the system is derived.

There is no need for the secure storage module to maintain a list of supplied data identifiers.

It should be mentioned that the embodiments describing the encrypting or decrypting could be combined with the embodiments describing the generation of the file name.

Referring to FIG. 8, in the following an embodiment is explained at hand of an example.

A user runs an application computer program 202 which administrates passwords in a database on a mobile phone in order to enter a new password to be stored. The application's name in this example may be “Passwordsafe”. After having started the application computer program 202, the processor 608 on which the application computer program 202 runs, and/or the application generation circuit generates an identity information 408 for the application. The application identity generation circuit 404 generates e.g. the identity information “pws” from the application name. This identity information is the first part of the input for the key generation circuit 414.

The second part may be a hardware unique key. The processor 608 in this example may have a serial number “123456”. The key generation circuit 414 now generates a key 430 from the application identity information and the serial number. Let the key be “&abc@def”, for example.

As a derivation of the serial number of the processor is part of the cryptographic key 430, the cryptographic key 430 cannot be generated on another mobile phone having a processor 608 with another serial number.

The password shall now be stored in a file 422. For that, a file name has to be generated. The file name generator 412 generates the following name:

“/home/store/secure/pws_{—}451.dat”.

As the application 202 does not know its identification “pws” it is useless for an attacker to obtain the file name 424 and the application identification information part 408 of the key 430. Thus, an attacker would have to crack both, the hardware unique key 418 and the application identity to obtain the key. Furthermore, the application identity information 408 is generated during runtime and is not stored.

Let the data to be stored be a single password “my_pwd”. The ciphering circuit 416 encrypts the password and stores the encrypted password in the file 422 on the memory 804.

If, just as an example, a block cipher encryption algorithm is used, the password is encrypted to a string with the same length, e.g. “xyz1R2q”.

If the user closes the application 202 the key 430 and all identifiers 406, 408 are not existent in the system.

If the user wants to retrieve the stored password in a later session, the key 430 and the file name 422 are generated in the same way as in the case of storing. In this way the key “&abc@def ” is obtained again. The application computer program 202 requests to read of the file 422 and to get and decrypt the encrypted password “xyz1R2q”. The application 202 provides the data identifier “451”, i.e. the identifier which indicates which of the data shall be retrieved. The deciphering circuit 416 reads and deciphers the password again to “my_pwd” and passes it to the application computer program 202. Alternatively, the whole file may be decrypted and passed to the application where it is processed then.

While the invention has been particularly shown and described with reference to specific embodiments, it should be understood by those skilled in the art that various changes in form and detail may be maid therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for generating a cryptographic key, the method comprising:
generating the cryptographic key using hardware device identification information and application computer program identification information.

2. The method of claim 1,
wherein the cryptographic key is generated while an application computer program being identified by the application computer program identification information is running.

3. The method of claim 1,
wherein the application computer program identification information is unknown to the application computer program being identified by the application computer program identification information.

4. The method of claim 1,
wherein the hardware device is a device selected from a group of devices consisting of:
a chip;
a part of a chip; and
a memory device.

5. The method of claim 1,
performed in a mobile radio device.

6. A method for storing a file, the method comprising:
storing the file under a file name using application computer program identification information and data identification information provided by an application computer program being identified by the application computer program identification information.

7. The method of claim 6, further comprising:
generating a cryptographic key using hardware device identification information and the application computer program identification information; and
encrypting the file using the cryptographic key.

8. The method of claim 7,
wherein the cryptographic key is generated while the application computer program being identified by the application computer program identification information is running.

9. A key generating circuit for generating a cryptographic key,
wherein the key generating circuit being configured to generate the cryptographic key using hardware device identification information and application computer program identification information.

10. The key generating circuit of claim 9, further comprising:
a processor configured to run the application computer program being identified by the application computer program identification information,
wherein the key generating circuit is further configured to generate the cryptographic key while the processor runs the application computer program being identified by the application computer program identification information.

11. The key generating circuit of claim 9, further comprising:
an application computer program identification information generating circuit configured to generate the application computer program identification information.

12. The key generating circuit of claim 11,
wherein the application computer program identification information generating circuit is further configured to generate the application computer program identification information such that the application computer program identification information is unknown to the application computer program being identified by the application computer program identification information.

13. A cryptographic circuit arrangement, comprising:
a key generating circuit configured to generate a cryptographic key using hardware device identification information and application computer program identification information; and
a cryptographic circuit configured to provide a cryptographic mechanism using the generated cryptographic key.

14. The cryptographic circuit arrangement of claim 13,
wherein the cryptographic circuit is further configured to provide a cryptographic mechanism selected from a group of cryptographic mechanisms consisting of:
encryption;
decryption;
authentication; and
generation of hash values.

15. The cryptographic circuit arrangement of claim 13, further comprising:
a processor configured to run the application computer program being identified by the application computer program identification information,
wherein the key generating circuit is further configured to generate the cryptographic key while the processor runs the application computer program being identified by the application computer program identification information.

16. The cryptographic circuit arrangement of claim 13, further comprising:
an application computer program identification information generating circuit configured to generate the application computer program identification information.

17. The cryptographic circuit arrangement of claim 16,
wherein the application computer program identification information generating circuit is further configured to generate the application computer program identification information such that the application computer program identification information is unknown to the application computer program being identified by the application computer program identification information.

18. A cryptographic circuit arrangement, comprising:
a key generating circuit configured to generate a cryptographic key using hardware device identification information and application computer program identification information;
a cryptographic circuit being configured to provide a cryptographic mechanism using the generated cryptographic key; and
a hardware device being identified by the hardware device identification information.

19. The cryptographic circuit arrangement of claim 18,
wherein the cryptographic circuit is further configured to provide a cryptographic mechanism selected from a group of cryptographic mechanisms consisting of:
encryption;
decryption;
authentication; and
generation of hash values.

20. The cryptographic circuit arrangement of claim 18, further comprising:
a processor configured to run an application computer program being identified by the application computer program identification information,
wherein the key generating circuit is further configured to generate the cryptographic key while the processor runs the application computer program being identified by the application computer program identification information.

21. The cryptographic circuit arrangement of claim 18, further comprising:
an application computer program identification information generating circuit configured to generate the application computer program identification information.

22. The cryptographic circuit arrangement of claim 21,
wherein the application computer program identification information generating circuit is further configured to generate the application computer program identification information such that the application computer program identification information is unknown to the application computer program being identified by the application computer program identification information.

23. The cryptographic circuit arrangement of claim 18,
wherein the hardware device is a device selected from a group of devices consisting of:
a chip;
a part of a chip; and
a memory device.

24. The cryptographic circuit arrangement of claim 18, further comprising:
a memory configured to store an encrypted file, wherein the memory has a memory interface coupled with the cryptographic circuit to exchange the encrypted file between the memory and the cryptographic circuit.

25. The cryptographic circuit arrangement of claim 24, further comprising:
a file name generating circuit coupled with the memory and the cryptographic circuit, wherein the file name generating circuit is configured to generate a file name for the encrypted file to be stored in the memory using the application computer program identification information and the data identification information provided by the application computer program being identified by the application computer program identification information.
